(19) United States
(12) Patent Application Publication
(10) Pub. No.: US 2008/0059296 A1
(43) Pub. Date: Mar. 6, 2008

(54) Parking Area Advertising as Location Identifiers

(76) Inventor: Robert D. Schau, Topeka, KS (US)

Correspondence Address: CARDINAL LAW GROUP, Suite 2000, 1603 Orrington Avenue, Evanston, IL, 60201, US

(21) Appl. No.: 11/470,162

(22) Filed: Sep. 5, 2006

(51) Int. Cl. G06Q 30/00

(52) U.S. Cl. 705/14

(57) ABSTRACT

A method for providing parking location identifiers via advertising within a parking system includes determining theme advertising regions within a parking area, and providing advertisements within the parking area based on the determined theme advertising regions. Another method for advertising within a parking system includes determining theme advertising regions within a parking area, determining parking area usage and providing advertising offers to advertisers based on the determined theme advertising regions and determined parking region usage. Advertisements are received from the advertisers and are placed within the parking area based on the determined theme advertising regions.

### TECHNICAL FIELD OF THE INVENTION

This invention relates generally to areas for parking vehicles. More specifically, the invention relates to parking area advertising as location identifiers for parked vehicles.

### BACKGROUND OF THE INVENTION

Frequently, when parking a vehicle in a parking space in a large parking area, such as at a large shopping mall, airport, sports stadium, entertainment center, a large single level parking lot or a multi-story parking garage, the vehicle occupant(s) will forget the location where the vehicle was parked. Finding the lost vehicle may lead to a great loss of time, increased anxiety, and may expose the person(s) searching for the vehicle to safety risks (e.g., being robbed, navigating through garage traffic, etc.).

Most large parking areas, such the examples mentioned above, provide signs or markers bearing alpha and/or numeric indicators to identify the parking space or identify various subdivisions of the larger parking area to assist the vehicle occupant(s) in identifying the location, floor, or general area in which the vehicle is parked. However, the vehicle occupant(s) must rely upon their memory or write the indicators down, should they happen to have pen and paper handy, so that the vehicle can be located at a later time. Unfortunately, most vehicle occupant(s) fail to write down the indicators down and, in some instances, fail to remember the same therefore losing track of their parked vehicle.

Therefore, it would be desirable to provide an improved strategy for keeping track of a parked vehicle that overcomes the aforementioned and other disadvantages.

### SUMMARY OF THE INVENTION

A first aspect according to the invention provides a method of operating a parking system. The method includes determining theme advertising regions within a parking area and providing advertisements within the parking area based on the determined theme advertising regions.

A second aspect according to the invention provides a method of operating a parking system. The method includes determining theme advertising regions within a parking area. Parking region usage is determined within the parking area. Advertisement placement offers are provided to advertisers based on the determined theme advertising regions and determined parking region usage. Advertisements are received from the advertisers. Advertisements are provided within the parking area based on the determined theme advertising regions.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is an illustration of a one embodiment of a multi-level parking system, in accordance with the present invention;

FIG. 2 is an illustration of a one embodiment of a parking lot parking system, in accordance with the present invention;

FIG. 3 is a flow diagram of first embodiment of a method of operating a parking system, in accordance with the present invention; and

FIG. 4 is a flow diagram of first embodiment of a method of operating a parking system, in accordance with the present invention.

### Like reference numbers are used throughout the drawings to refer to like elements.

### DESCRIPTION OF THE PRESENTLY PREFERRED EMBODIMENTS

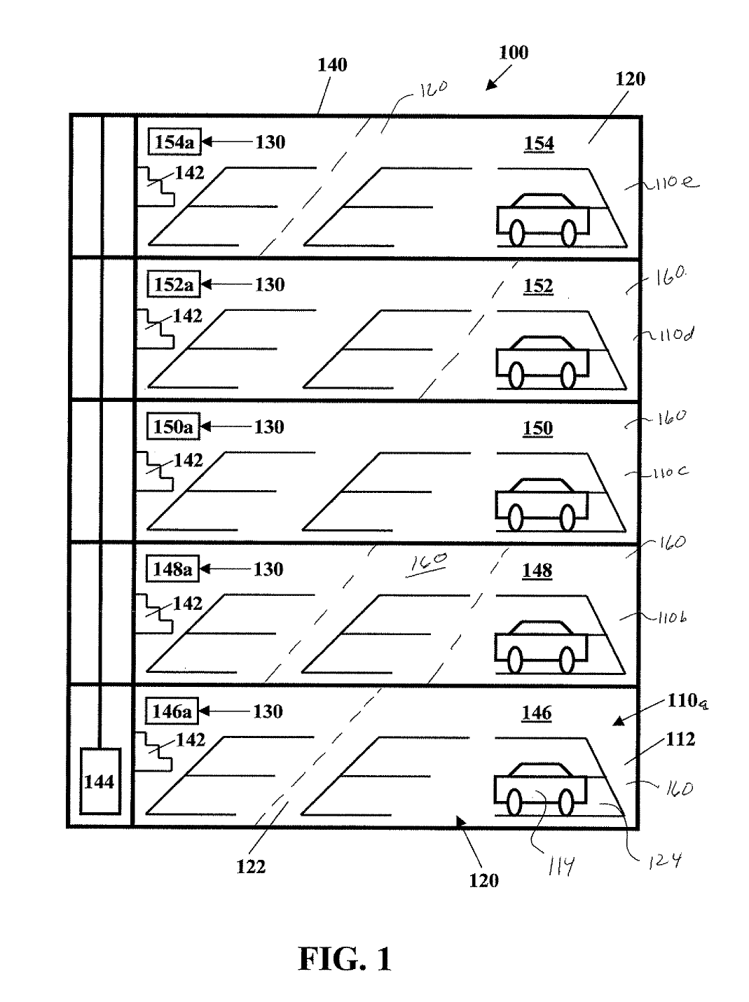

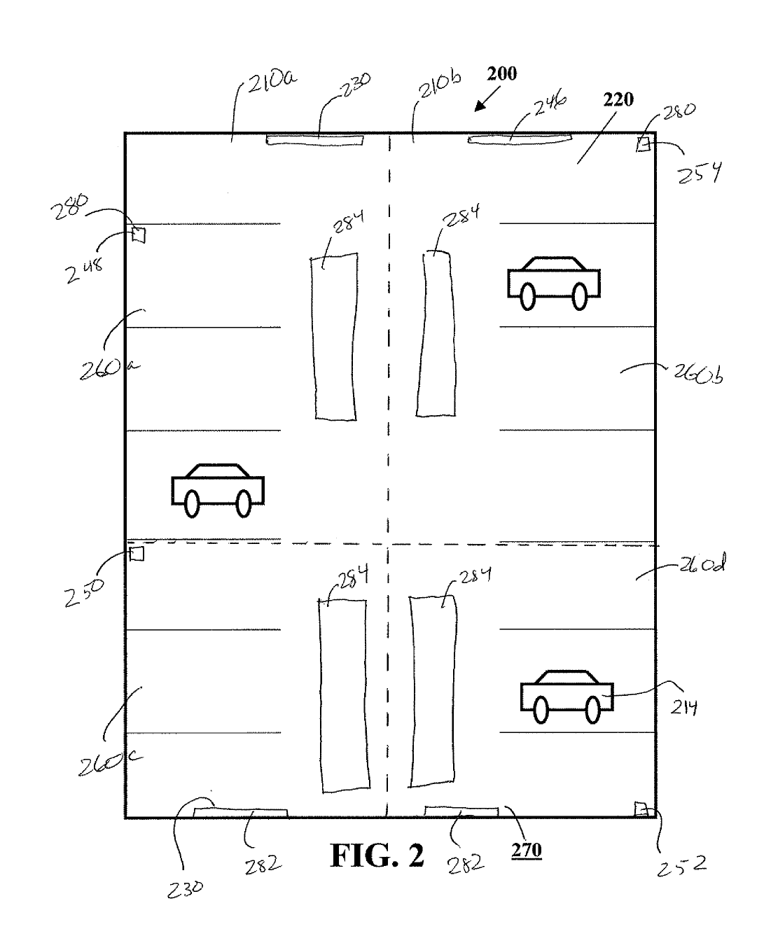

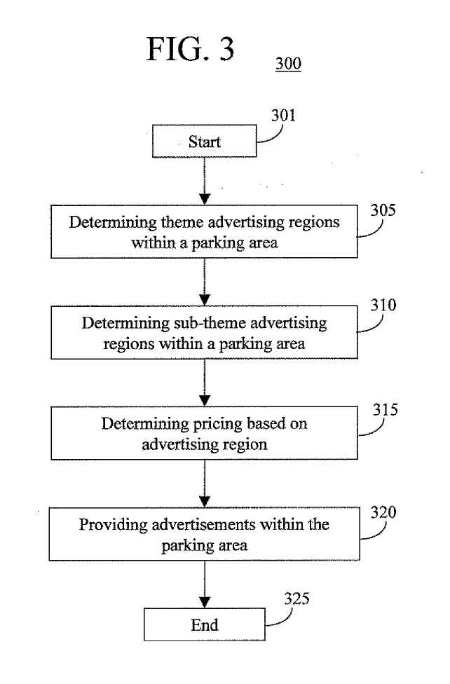

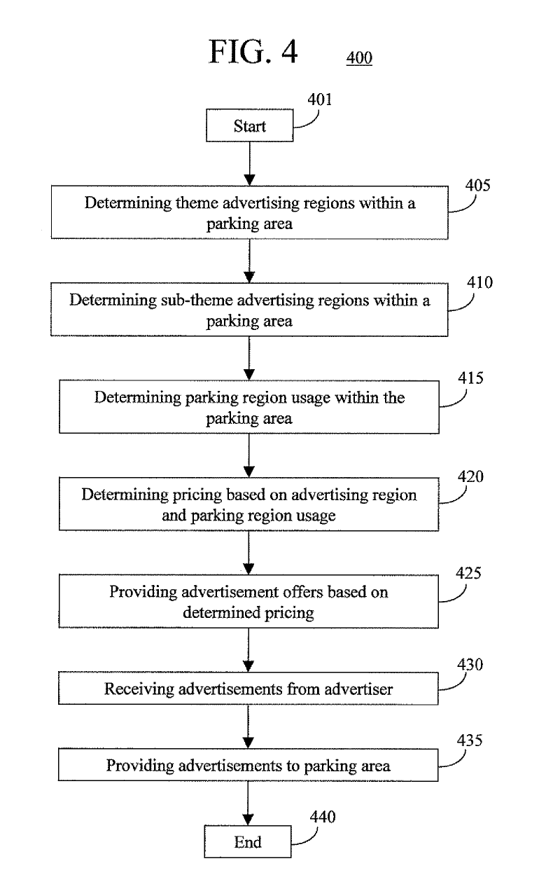

One aspect of the present invention is a method for providing parking location identifiers via advertising within a parking system. FIGS. 1 and 2 illustrate two different parking systems that may be used in conjunction with the methods for providing parking location identifiers via advertising discussed in more detail below and illustrated in FIGS. 3 to 4. FIG. 1 illustrates a system 100 within a multilevel parking garage and FIG. 2 illustrates a system 200 within a parking lot.

Referring to FIG. 1, system 100 comprises a parking area 120 for parking a plurality of vehicles 114. In system 100 parking area 120 comprises a parking garage 140 having a plurality of parking garage levels 146, 148, 150, 152, and

154. Vehicle passenger(s) may access multiple levels of the parking garage 140 via stairway(s) 142 and/or elevator(s) 144 leading to respective parking garage levels 146, 148, 150, 152, and 154. Vehicles are parked in individual parking spots 124 located in the parking area 120, which includes a main entrance/exit located on a ground floor 122.

In one embodiment, each parking garage level 146, 148, 150, 152, and 154 comprises an advertising region 110. In one embodiment, advertising region 110 is a themed advertising region. In one embodiment, themed advertising region 110 may be further divided into sub-theme advertising regions 160. In another embodiment, each advertising region comprises a plurality of unrelated advertisements. For example, the advertising region may include a myriad of advertisements with no discernible theme or affiliation with one particular company.

In one embodiment, an entire parking facility comprises a theme advertising region. For example, the theme may be related to beverages, vehicles, restaurants, and the like. In this embodiment, the theme advertising region may be divided into sub theme advertising regions by parking level or parking area depending on the type of parking facility. In one embodiment, theme advertising regions 110 comprise entire parking garage levels or sections of a parking area designated for placement of advertisements. In one embodiment, a theme advertising region 110 includes advertising relating to a specific company or a general category of goods or services. For example, each theme advertising region 110 may advertise a product brand (e.g., a beverage brand, a vehicle brand, and the like). In another example, a theme advertising region 110 may advertise local businesses such as, for example, local restaurants or retailers.

Each theme advertising region 110, in-turn, may further be subdivided into sub-theme advertising regions 160 representing product sub-brands (e.g., unique flavors/varieties of the beverage brand, unique models of the vehicle brand, and the like).

In an example, each parking level of a multilevel parking garage comprises a different theme as compared to the other levels of the parking garage. For example, one level advertises beverages, while the next level advertises vehicles and the next level advertises snack food products. This pattern of theme advertising continues for all levels of the parking garage such that no two levels have the same theme. A similar arrangement can be utilized in a parking lot type parking facility. For example, a parking lot of ten acres may comprise ten different advertising theme areas. In this embodiment, each acre of theme advertising may then be subdivided into sub-theme advertising areas.

A plurality of advertisements 130 are provided within the theme advertising regions 110 and the sub theme advertising regions 160. In one embodiment of system 100, each parking garage level 146, 148, 150, 152, and 154 includes at least one advertisement sign 146a, 148a, 150a, 152a, and 154a (e.g., ads). In one embodiment, the ads 146a, 148a, 150a, 152a, and 154a are unique to distinguish the respective parking levels 146, 148, 150, 152, and 154 from one another. Advertisement signs 146a, 148a, 150a, 152a, and 154a may be video displays, static or movable signs (e.g., billboards), audible sound emitting devices (e.g., speakers), a combination thereof, and/or any other means for communicating an advertisement slogan, jingle, video, picture, and the like. In addition, the advertisement signs 146a, 148a, 150a, 152a, and 154a may additionally include other information, such as garage level number.

In one embodiment, the ads 146a, 148a, 150a, 152a, and 154a may be positioned on a plurality of parking area surfaces. For example, the ads 146a, 148a, 150a, 152a, and 154a may be positioned on walls, floors, support pillars, lampposts, elevator doors, elevator buttons, elevator walls and/or pavement. Those skilled in the art will appreciate that the type of advertisement signs and their positioning may vary and are not limited to the examples provided herein.

In practice, vehicle passenger(s) are guided to a theme advertising region 110 (e.g., floor) where their vehicle is parked by recalling the advertised product or service, and more specifically to a proper sub-theme advertising region 160 by recalling the advertised product sub-brand. Since product brands and sub-brands are generally easier to recall than seemingly ambiguous number(s) and/or letter(s), the vehicle passenger(s) are less likely to lose track of their parked vehicle. To further assist the vehicle passenger(s) to locate their vehicle, guide(s) may be provided within various areas within the parking garage 140. For example, the guide(s) may be positioned at or near the parking garage 140 entrance(s)/exit(s), the elevator(s), the stairwell(s), doorway(s), and the like. The guide(s) may include the theme and sub-theme advertising regions by respective parking levels 146, 148, 150, 152, and 154 for reference to the vehicle passenger(s).

In another embodiment, as shown in FIG. 2, the parking area 220 is a parking lot 270 wherein the theme advertising regions 210 comprise a plurality of predetermined locations within the parking lot 270. In another embodiment, theme advertising regions 210 may be further divided into sub-theme advertising regions 260.

A plurality of advertisements 230 is provided within the theme advertising regions 210a, 210b and the sub theme advertising regions 260a to 260d. In one embodiment of system 200, each theme advertising region 210a, 210b and sub theme advertising region 260a to 260d includes at least one advertisement. In one embodiment, the ads 246, 248, 250, 252, and 254 are unique to distinguish the respective sub theme advertising region 260a to 260d from one another. Advertisement signs 246, 248, 250, 252, and 254 may be video displays, static or movable signs (e.g., billboards), audible sound emitting devices (e.g., speakers), a combination thereof, and/or any other means for communicating an advertisement slogan, jingle, video, picture, and the like. In another embodiment, advertising is placed on or adjacent to monitors that show parking area patrons the location of available parking spaces.

In one embodiment, the ads 246, 248, 250, 252, and 254 may be positioned on a plurality of parking area surfaces. For example, the ads 230 may be positioned on lampposts 280, billboards 282 and/or pavement 284. Those skilled in the art will appreciate that the type of advertisement signs and their positioning may vary and are not limited to the examples provided herein.

While the present invention is presented in the form of the embodiments included herein, the invention is not limited to the detailed description and drawings provided. The invention disclosed is applicable to many conventional parking methods and parking systems besides the embodiments shown and described herein. It should be understood that the present disclosure is to be considered an exemplification of the principles of the invention and is not intended to limit the spirit and scope of the invention and/or claims to the embodiments described and illustrated.

Another aspect of the present invention is a method 300 for providing parking location identifiers using advertising within a parking system. FIG. 3 is a flow diagram of one embodiment of a method 300 in accordance with the present invention. Method 300 utilizes a parking system such as systems 100 and 200 illustrated in FIGS. 1 and 2. Method 300 begins at step 301.

Theme advertising regions are determined within a parking area at step 305. The theme advertising regions 110, 210 may be determined as described above and illustrated in FIGS. 1 and 2. In one embodiment, the theme advertising regions may be divided by floor in a multi-level parking garage. In another embodiment, the theme advertising regions may be divided by predetermined locations within a parking lot 270. In another or the same embodiment, the theme advertising regions may be determined to maximize advertising exposure by specific brand, to maximize profits, and/or some other criterion. Those skilled in the art will recognize that the theme advertising regions may be determined by various factors not limited to the examples provided herein.

Next, at step 310, sub-theme advertising regions 160, 260 are determined within the theme advertising regions 110, 210. The sub-theme advertising regions may be determined as described above and illustrated in FIGS. 1 and 2. In one embodiment, the sub-theme advertising regions may be divided within a given parking level theme advertising region of a multi-level parking garage 140. In another embodiment, the sub-theme advertising regions may be divided by predetermined locations within a theme advertising region in a parking lot 270. In another or the same embodiment, the sub-theme advertising regions may be divided by specific sub-brands in order to maximize advertising exposure and to maximize advertising revenue. Those skilled in the art will recognize that the sub-theme advertising regions may be determined by various factors such as, for example, the popularity and/or the commercial appeal of the advertised good or service. In an example, popular consumer products may be advertised in a sub-theme area closer to an entry/exit point of the vehicle and/or the parking facility patron.

Pricing is determined for advertisement placement within the theme advertising regions, at step 315. In one embodiment, pricing is determined based on parking region usage. In one embodiment, parking regions with greater usage demand a premium advertising price as compared to parking regions with lesser usage. For example, the lower floors in a multi-level parking garage or the parking area adjacent to the main entrance/exit of a parking lot demand a premium advertising price based on increased traffic flow through these areas as compared to parking areas on upper floors or further from the entrance/exit of a parking lot. In one embodiment, advertising pricing correlates with the increased exposure of ads to the parking area patrons. In another embodiment, pricing for advertising is based on the size and physical nature of the parking facility and/or the availability of surfaces for placement of the advertisements within and around the parking region. Other factors that may be used to determine pricing include, but are not limited to, population density, number of available parking facilities, average number of daily users, and the like. In an example, advertising pricing may be increased for all advertising regions within a parking facility located in a densely populated area based on an average daily usage that indicates that at any given time during regular business hours the parking facility is at or near capacity.

Advertisements are provided within the parking area based on the determined theme advertising regions and/or the determined sub-theme advertising regions at step 320. This may be accomplished as described previously as, for example, providing advertisement signs, billboards, videos, and the like. Placement of the provided advertisements may be determined based on such factors as, for example, the number of ads to be placed, the size of the parking facility, the size of the ads to be placed, the physical nature of the parking facility, and the like. Placement of the ads is also determined by the “theme” and/or “sub-theme” of the region in which the ad will be positioned. In an example, a theme advertising region may comprise a particular beverage brand theme with sub-themes comprising particular beverages belonging to that brand. It is contemplated that numerous strategies may be used for providing and positioning the advertisement signs within the parking area. In one embodiment, advertisements are placed in areas adjacent the parking areas. For example, advertisements may be placed on walls and other surfaces that lead to or from the parking area. In other embodiments, advertisements may be placed in, on or around elevators that service multilevel parking garages. Method 300 ends at step 325.

FIG. 4 illustrates a flow diagram of another embodiment of a method 400 for advertising in a parking system, in accordance with the present invention. Method 400 utilizes a parking system such as systems 100 and 200 illustrated in FIGS. 1 and 2. Method 400 begins at 401.

Theme advertising regions are determined within a parking area at step 405. The theme advertising regions 110, 210 may be determined as described above and illustrated in FIGS. 1 and 2. In one embodiment, theme advertising regions are determined in the same manner as in step 305, above.

Next, at step 410, sub-theme advertising regions 160, 260 are determined within the theme advertising regions 110, 210. The sub-theme advertising regions may be determined as described above and illustrated in FIGS. 1 and 2. In one embodiment, theme advertising regions are determined in the same manner as in step 310, above.

Parking region usage is determined within the parking area (step 415). In one embodiment, parking regions with greater parking occupancy are determined as having a higher parking region usage. In another or the same embodiment, parking regions with greater vehicle and/or foot traffic are determined as having a higher parking region usage. In yet another embodiment, parking region usage is determined by location of the particular parking area. In an example, lower levels of a parking garage may be determined to have a higher usage than upper levels of a multi-level parking facility such as that illustrated in FIG. 1. In another example, parking areas within a parking lot that are closer to a vehicle entrance or exit may be determined to have a higher usage due to the proximity to the entrance and/or exit. In yet another embodiment, parking region usage may be determined by population density, number of average daily users, and the like.

Next, at step 420, advertising pricing is determined. In one embodiment, advertising pricing is determined based on advertising region (theme or sub-theme) and parking region usage. In one embodiment, advertising pricing may be determined in the same or similar manner as at step 315, above.

Advertisement offers are provided to advertisers based on the determined theme advertising regions and determined parking region usage at step 425. In one embodiment, advertisement offers include terms regarding pricing, number of advertisements, advertising region and placement location of the advertisements.

Advertisements are received from the advertisers, at step 430, in accordance with the advertisement offer provided to the advertiser in step 425. The advertisement or plurality of advertisements may be in any form suitable to the advertiser. The advertisements may comprise a variety of different types of advertisements, such as, posters, video transmissions, audio transmissions, as well as any other type of advertisement well known in the art. The advertisements may include theme and/or sub-theme advertising regions. The advertisements may also include, or be divided among, brand and/or sub-brands of the particular advertiser.

Advertisements are provided within the parking area based on the determined theme advertising regions, at step 435. This may be accomplished as described previously as, for example, providing advertisement signs. Those skilled in the art will appreciate that numerous strategies may be used for providing and positioning the advertisement signs within the parking area. Method 400 ends at 440.

In one embodiment of method 400, an advertising clearinghouse is provided as an intermediary between a parking facility owner/operator and one or more advertisers. In this embodiment, the clearinghouse reviews the parking facility to determine the advertising regions and the parking facility usage. The advertising clearinghouse then determines a pricing structure and offers advertising proposals to potential advertisers. In one embodiment, the advertising clearinghouse negotiates the terms of an advertising agreement with the advertiser. In another embodiment, the advertising clearinghouse merely acts as an intermediary during agreement negotiations.

In another embodiment, the advertising clearinghouse accepts the advertising provided by the advertiser and installs the advertisements in the parking facility or arranges for the installation via a third party. In another embodiment, the advertising clearinghouse provides the advertisements to the parking facility owner/operator who installs or has installed the provided advertising.

While the embodiments of the invention disclosed herein are presently considered to be preferred, various changes and modifications can be made without departing from the spirit and scope of the invention. The scope of the invention is indicated in the appended claims, and all changes and modifications that come within the meaning and range of equivalents are intended to be embraced therein.

1. Method of operating a parking system, the method comprising:
determining theme advertising regions within a parking area; and
providing advertisements within the parking area based on the determined theme advertising regions.

2. The method of claim 1 wherein the parking area comprises a parking garage, wherein the theme advertising regions comprise a plurality of floor levels within the parking garage.

3. The method of claim 1 wherein the parking area comprises a parking lot, wherein the theme advertising regions are a plurality of predetermined locations within the parking lot.

4. The method of claim 1 further comprising:
determining pricing for advertisement placement within the theme advertising regions based on parking region usage.

5. The method of claim 1 further comprising:
determining sub-theme advertising regions within the theme advertising regions; and
providing advertisements within the parking area based on the determined sub-theme advertising regions.

6. The method of claim 5 wherein providing advertisements within the parking area comprises providing at least one of an advertisement slogan, jingle, video, and picture.

7. The method of claim 5 wherein providing advertisements within the parking area comprises displaying ads on a plurality of parking area surfaces.

8. The method of claim 7 wherein the parking area surfaces comprise one or more surfaces selected from the group consisting of: walls, floors, support pillars, lamp posts, elevator doors, elevator buttons, elevator walls and pavement.

9. A method of operating a parking system, the method comprising:
determining theme advertising regions within a parking area;
determining parking region usage within the parking area;
providing advertisement placement offers to advertisers based on the determined theme advertising regions and determined parking region usage;
receiving advertisements from the advertisers; and
providing advertisements within the parking area based on the determined theme advertising regions.

10. The method of claim 9 wherein the parking area comprises a parking garage wherein the theme advertising regions comprise a plurality of floor levels within the parking garage.

11. The method of claim 9 wherein the parking area comprises a parking lot wherein the theme advertising regions comprise a plurality of predetermined locations within the parking lot.

12. The method of claim 9 further comprising:
determining pricing for advertisement placement within the theme advertising regions based on the determined parking region usage and the determined theme advertising region.

13. The method of claim 9 further comprising:
determining sub-theme advertising regions within the theme advertising regions; and
providing advertisements within the parking area based on the sub-theme advertising regions.

14. The method of claim 13 wherein providing advertisements within the parking area comprises providing at least one of an advertisement slogan, jingle, video, and picture.

15. The method of claim 13 wherein providing advertisements within the parking area comprises displaying ads on a plurality of parking area surfaces.

16. The method of claim 15 wherein the parking area surfaces comprise one or more surfaces selected from the group consisting of: walls, floors, support pillars, lamp posts, elevator doors, elevator buttons, elevator walls and pavement.
